(19) United States
(12) Patent Application Publication
(10) Pub. No.: US 2009/0006411 A1
(43) Pub. Date: Jan. 1, 2009

(54) Strategic Business Management System

(75) Inventors: Milind Madhukar Lele, Evanston, IL (US); Sukumar Chandrakant Thanawala, Naperville, IL (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(73) Assignee: SLC CONSULTANTS, INC., Evanston, IL (US)

(21) Appl. No.: 12/057,112

(22) Filed: Mar. 27, 2008

Related U.S. Application Data
(60) Provisional application No. 60/908,317, filed on Mar. 27, 2007.

(51) Int. Cl. G06F 17/30

(52) U.S. Cl. 707/9; 707/100; 707/103 R; 707/E17.045; 707/E17.055

(57) ABSTRACT

A subject focused information management system is provided based upon an object oriented hub and spoke topology. The information management system provides a structured and secure logically central means for retrieving and storing data oriented by topics and subject matter interests.

### RELATED APPLICATIONS

This application claims priority to U.S. provisional patent application Ser. No. 60/908,317 filed on Mar. 27, 2007, which is incorporated by reference in its entirety herein.

### FIELD OF THE INVENTION

This invention relates generally to information exchange systems, and more specifically to a system and methods for managing and exchanging business or personal related information in a secured environment.

### BACKGROUND OF THE INVENTION

A common and increasingly significant problem associated with the changing business climate is the distraction associated with electronic communications, often taking the form of email and instant messaging, and the difficulty of gathering critical information from disparate data sources within organizations, which may reside in a variety of enterprise data systems. Recent workplace studies have indicated that the majority of office workers check and respond to email as it arrives in their email inbox and are constantly interrupted by instant messages (if used by the organization). In many companies this is translated into a distraction and disruption from other activities every few minutes in order to check the contents of the new emails. According to various productivity studies, it takes anywhere from 8-15 minutes after a disruption of any type to return to a thought process to become fully engaged in another activity. As a result many office workers and executives are unable to fully devote their concentration to projects, business strategies, or their employees' development. Focusing and assessing work priorities has become increasingly confused through the currently available business communication formats as the volume of email increases messaging increases while data critical for running the business remains stranded in data systems or reports.

Entities that require communications among numerous computer system users face significant challenges in keeping business team members focused on relevant goals, strategic initiatives and performance data. Using an email system as a collaboration tool leads to large volumes of email for all parties, disjointed communications, scattered attachments which becomes difficult for team members when they need to find and utilize the information for decision making at a later point. As a result, maintaining communication among team users on a specific topic can be difficult. While email has at the same time increased the ease of 1-to 1 communication; uses for team interaction (1-many, many-to-many) provide a significant distraction to users. Additionally, project management and available “collaboration” tools are designed for the individual user to manage projects (and are not built around business team priorities and needs) and reside outside normal workflow.

Email and instant messaging often decrease the time spent on more important tasks and have blurred the lines between what is truly “important” and what is “urgent”; where responding to email in a timely fashion has become more “urgent” than focusing on critical business projects and initiatives. Frequent email usage often leads to reduced face-to-face communication, proactive thinking, and time for creative thinking. Potentially more damaging than the actual time spent on email, is the time needed for workers to re-focus their thoughts and energies upon crucial business initiatives.

The potential cost to a business or volunteer entity of prolific email usage can be staggering, as it is estimated that an average executive spends one (1) to two (2) hours each day addressing email communications. It is further estimated that approximately 60% of the executives email is comprised of non-essential communications, or communications that are non-essential at the time of their receipt. Though it depends upon the entity, most email does not require immediate or any action whatsoever.

Previous attempts to solve some of the problems associated with business communication include improvements to Microsoft Outlook email such as Zimbra, Inc. (www.zimbra.com, 1500 Fashion Island, Suite 100, San Mateo, Calif. 94404). Zimbra offers integrated tools for managing high volumes of email; it is not a solution for business team communication/information exchange; collaboration tools such as SocialText, (www.socialtext.com, 655 High Street, Palo Alto, Calif. 94301) offers unstructured enterprise wiki systems that allow the individual to set up blank wikis for use by preset users; it is not designed around the priorities of the business. Another previous attempt includes webexone™ (www.weboffice.com), which provides websites where users can exchange documents, but has limited messaging functionality and is not aligned around the business organization or its priorities; its features are designed for the individual user not the team and management. eRooms provide a central place for teams to exchange attachments but more often require an administrator and the systems generate email to notify users that attachments have been added to the eRoom, thereby defeating the purpose. Instant messaging systems are for short term, fast communication and are therefore not relevant for use for large teams working together to accomplish common longer-term goals. Document management tools are good for managing attachment libraries but are completely disconnected from communication and collaboration. Many of these tools also require the user to leave natural work streams and are often cumbersome to learn (the process of both storing and retrieving documents).

It would be advantageous for a computer based communication system to enhance productivity, reduce the occurrence of non-essential communications and pre-organize communication and attachments around common business priorities. It would be of further advantage if the computer based system was subject matter focused (including on-going functional business activities, management news, administrative information and strategic initiatives). It would be of further advantage if the communication system provided a central depository for all team work leading to reduced file storage redundancy. It would be of yet a further advantage if the computer based system resulted in enhanced efficiency and focus upon pre-defined goals. It would be of further advantage for a computer based communication system to have instant access to performance metrics for the business. It would be of still further advantage if the computer based communication system delivered user defined topics to a “favorites” section for quick access and had them delivered to their Blackberry™ (or handheld equivalent) if they are away from their computer. Of still further advantage would be if any user could set up a private discussion with a sub-set of the team and exchange attachments on any topic. This would be of still further benefit to the user if updates to these discussions would be highlighted on their screen and then delivered to their Blackberry (or handheld equivalent) if they were away from their computer. Finally, it would be also be of advantage if users could send private messages to other users in the system regarding topics germane to the team. This would be of still further advantage if these messages were highlighted on a users computer screen and then delivered to their Blackberry or PDA equivalent if the user is away from their computer.

### BRIEF DESCRIPTION OF THE DRAWINGS

FIG. 1 is an illustrative example of the communication system.

FIG. 2 is an alternative illustrative example of the communication system.

FIG. 3 is an illustrative example of the communication structure.

FIG. 4 is an illustrative example of one embodiment of the user interface.

FIG. 5 is an illustrative example of an alternative embodiment of the user interface.

FIG. 6 is an illustrative example of an alternative view of the user interface shown in FIG. 5.

FIG. 7 is an illustrative abstract example of electronic mail types.

FIG. 8 is an illustrative example of an alternative embodiment of the user interface.

FIG. 9 is an illustrative example of an alternative embodiment of the user interface.

FIG. 10 is an illustrative example of an alternative embodiment of the user interface.

FIG. 11 is an illustrative example of an alternative embodiment of the user interface.

FIG. 12 is an illustrative example of an alternative embodiment of the user interface.

FIG. 13 is an illustrative example of an alternative embodiment of the user interface.

FIG. 14 is an exemplary content storage database schema in accordance with at least one embodiment of the present invention.

FIG. 15 is a logical flow chart in accordance with at least one embodiment of the present invention representing a topic based team discussion.

FIG. 16 is a logical flow chart in accordance with at least one embodiment of the present invention representing a t-gram submission.

### DETAILED DESCRIPTION OF THE INVENTION

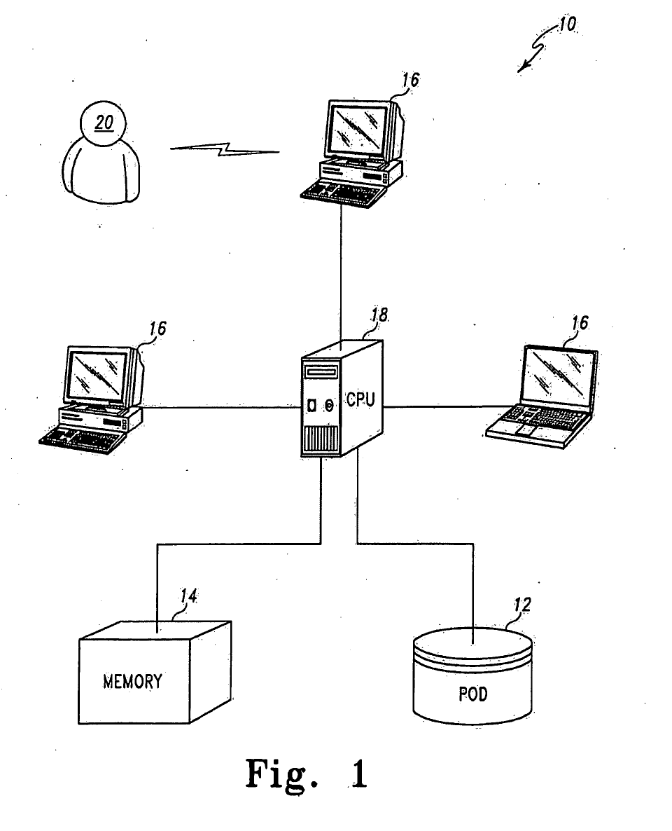

Referring to FIG. 1, an illustrative example of a computer-based, subject-focused communication system 10 is shown. The system 10 includes a data file storage pod 12, a memory storage device 14, a user interface 16, and a central processing unit (CPU) 18. The pod 12 can be selected from a relational database, a network database, a hierarchical database, or any other suitable data structure. Data files are organized by the pod 12 and stored in memory 14. The CPU 18 directs the pod 12 to access data files stored in memory 14. Data file access includes both read and write operations to memory 14. Each user interface 16 is accessed by at least one user, and the system 10 is preferably accessed by multiple users.

In an alternative embodiment, a single user 20 communicates with the system 10. In this alternative arrangement, it is contemplated that the work performed by a single user is accessible by alternate users at the same or later time. In either a single or multiple user communication system 10 topic oriented data is archived for later retrieval. The memory storage device 14 stores data files and computer based functions performed by the system 10. Memory 14 may alternatively be integral with CPU 18.

The communication system is focused around a particular subject or topic that is of particular interest to one or more users. By example, in the corporate setting a topic can include legal issues, corporate governance, product development, research and development, as well as human resources. Sub-topics can be created and user access rights restricted within a particular sub-topic. By example, the product development topic may have consumer products and/or a particular product project as a specific sub-topic. A team of users is mobilized for developing a new consumer product. In order to maximize efficiency, organization, and resource allocation each of the team members is granted access to the sub-topic and is capable of storing and retrieving data related to that particular product development project. The system 10 can be logically considered to have a hub and spoke topology, where the database and associated user interface is an information hub focused upon a particular topic or subject. Users access and provide data to the hub, thereby acting as individual spokes.

From a logical standpoint, there is a user object which represents an individual. The logical user object determines the access granted for a particular user in combination with the view object. The view object is a logical object which provides an organizational link to a plurality of objects. Based upon the user object access, the user can access the plurality of objects selected from the group including messages, discussions, t-grams, key performance indicators, my to-dos, tasks and documents. Alternatively, there are additional logical objects that are contemplated and implemented in the system. The My To-Dos object is a group of T-grams which the user must take action upon.

User interface 16 provides a means for system users 20 to access data files and the functionality of the system 10. The interface 16 can be selected from a variety of devices, including a PC computer, a MAC computer, a laptop computer, a terminal computer, a handheld computer, a tablet computer, or any other suitable interface known in the art.

Data files accessed from memory 14 are associated with one or more pods 12 and the pods 12 represent a communication subject. Alternatively, a pod 12 can represent a communication topic. One or more communication topics are associated with each communication subject. As data is received from users the system 10 can dynamically and automatically sort, tag, and cluster information within the pod 12, which can be retrieved. The user can import data files, including expired patents, emails, messages, and attachments.

The pods 12 are accessible through a web-based user interface and organized by “tabs” 11 at the top of the site for each different user group or by function. By example, tabs 11 can include functions such as sales, marketing, finance and product development tabs 11, which can also include product or service categories such as iPod, PowerMac, and iSight.

Each tab 11 represents a web-based team page. By example, team pages can include sales, marketing, finance, and legal. All work for that team occurs on that page and is divided into three columns: Column 1 contains “my work” which is relevant to the specific user; Column 2 contains “management information” and; Column 3 contains team initiatives and functional news.

Alternatively, user's page can be customizable, including a subset of information and content from a variety of different team pages. By example, an executive within a corporation may be granted access separately to an executive, financial, and legal team. In order to streamline the delivery of data from these separate team pages, the executive can create a new page that provides the most pertinent content for all the teams the executive has access.

A first webpage column, which can be referred to as “my column” is specific information for the individual user that can be categorized into four categories:
1. My Messages: One-to-one or one-to-few messaging for use regarding team specific information exchange. These communications are often private, but can alternatively be made viewable to additional users.
2. My Discussions: All of the discussions that the individual user has either started or been invited to participate. These communications are often private, but can alternatively be made viewable to additional users.
3. My T-grams: T-grams are compiled based upon topic or sub-topic areas that the individual user is most interested in receiving. Users select multiple topics from any tab 11 they have access to view. The database then aggregates new t-grams and presents them in this section. Also, if the user is logged off the system, the system delivers the new t-grams to the user's Blackberry or handheld equivalent, which can be delivered regardless of connectivity. T-grams are made available to all members of a team, or those users which have been granted access to the particular Tangram hub.
4. My Initiatives: The user selects their personal initiatives from the initiatives in column 3 of any tab 11 for which they have access. The system then sends any new t-grams or comments to existing t-grams and attachments to this section. Again, if the user is logged off, the stories are delivered to their Blackberry of handheld equivalent.

A second webpage column includes a section for performance data. Data can be uploaded in a spreadsheet format, such as Microsoft Excel, or fed directly to us via live feed from many different corporate data system types. Data is then displayed numerically or graphically according to the preferences of the team leader (usually the general manager of the business or the functional leader). The lower section of this column is devoted to two topics (although more can be added) including Management News (for the team leader to update the team and respond to inquiries) and Top News (news relevant for the group such as competitive information, best practices, etc).

A third webpage column can include key strategic initiatives of the business teams. This is usually tied to a strategic scorecard or strategic planning document of some type. A section of column 3 is devoted to functional (e.g., sales/marketing/manufacturing)/product (e.g., ipod nano, ipod shuffle, ipod video) or service (e.g., customer service, post-sales support) topics.

Additionally, the system 10 can provide alternative features for each or selected users. By example, a webpage link can be provided, when selected a particular level of content is provided to the user. News information can be provided within such an interactive webpage, which may be referred to as “My Asked Fors”, which is another logical object. Such a webpage provides specific content requested by the user and allows the user to add information to the webpage and select whether the content is accessible to a particular team. Team members can be selected to comment on news or various other types of postings, which can be requested by the team leader or other team members. This can provide useful commentary to the team regarding a particular subject, which can be viewed by the team members.

An additional webpage can be provided with the present system, which enables a user to select content or Tgrams of interest for easy accessibility. The user can grant access to all or none of the team members, which can comment on the content selected by the user.

Yet another additional webpage display capability for at least one embodiment of the present invention lists the current and future responsibilities and requested action for a particular user. Such a webpage can provide a “to-do” list for a particular user, which can be organized in a variety of ways and include tasks assigned to a user by others as well as those assigned by the user. These tasks, as well as other time related events, can be logically linked to a calendar page. The calendar page can provide the user a graphical view of a task completion timeline.

An additional content webpage can be provided for purpose of topic discussion. The discussion page provides a central forum for team members to add and view commentary based upon specific or random topics. Each discussion can be logically organized to identify the topic, the host user, the discussion participants, the time stamp for each comment, and the time stamp for the last comment. Additional content and organization is contemplated.

All topics are posted to the site by title and description and are known as “t-grams” or “tangrams”. When posting t-grams users must select from a list of predetermined topics and sub-topics from drop-down menus that have been programmed during the set up process (e.g. Topic: Sales, Sub-topic: Big Box Retailers OR Topic: Manufacturing, Sub-topic: Six Sigma). Alternatively, users can add topics and sub-topics that have not been pre-programmed, typically these users are those having administrative governing authority. T-grams can then be given a unique title and description, and a story must be written (much like the contents section of an email), t-grams can then be set to automatically archive once they are no longer relevant (e.g., a sales report that is generated every week can be archived after seven days in preparation for the new report). Attachments can then be added from the users hard drive or from an eRoom (if they specify the correct path). All t-grams can be “elevated” to the management Tangram page if the user feels management should review the information; a box can be checked before (or after) the t-gram is submitted and a “mirror” of the t-gram, the attachment(s) and any related comments is created on the management page.

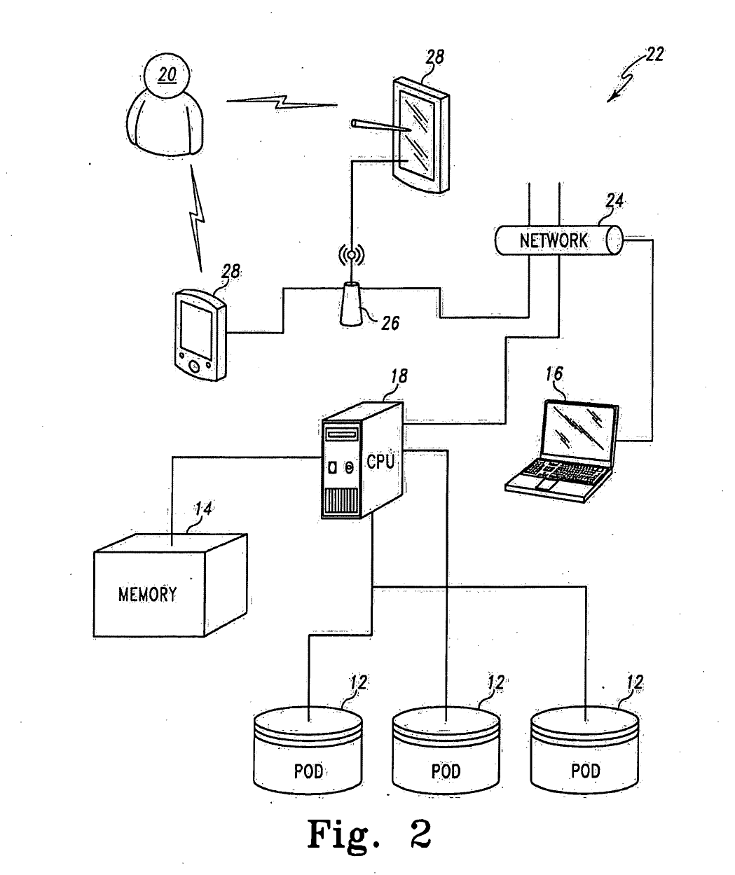

Referring to FIG. 2, an alternative illustrative example of the computer-based, subject focused communication system 22 is shown. The system 22 includes a plurality of pods 12, a memory storage device 14, user interface 16, a network 24, a wireless access point 26, and wireless interface 28. The network 24 is an Ethernet. Alternatively, the network can be a ring network or any other suitable network configuration. The wireless access point 26 provides users 20 wireless connectivity to the system 22. Wireless interface 28 is connected wirelessly through the access point 26. Wireless interfaces 28 are selected from a group including PDAs, tablet PCs, Blackberrys, cellular phones, smartphones, and a variety of other suitable devices known in the art.

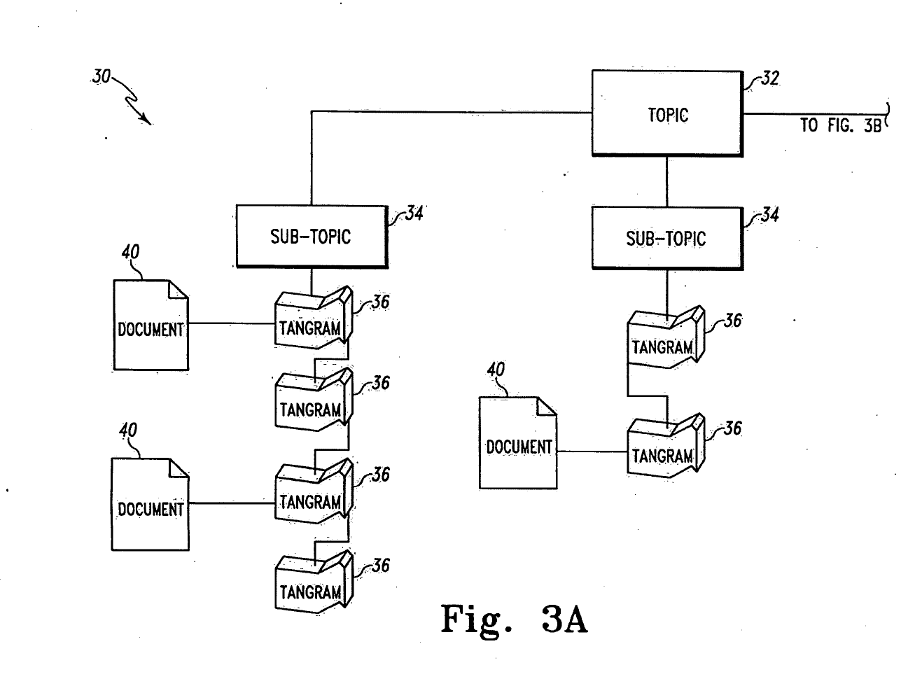

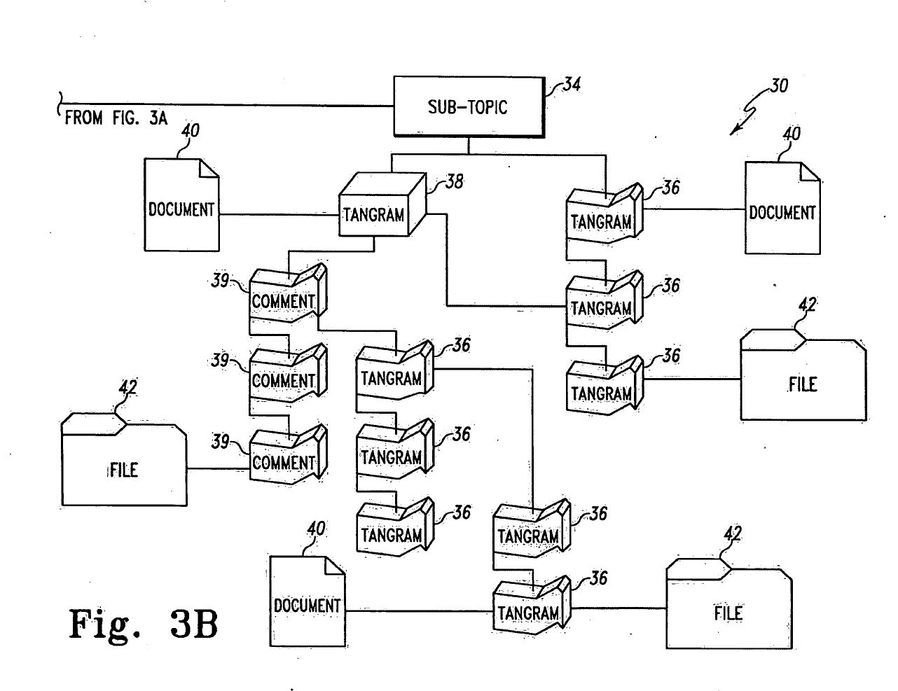

Referring to FIG. 3, an illustrative example of the conceptual data file arrangement 30 within pod 12 (FIG. 1) is shown. The data arrangement 30 is organized in a hierarchical manner. Within each pod 12 is a topic 32, subtopic 34, tangram 36, conversation tangram 38, and comment 39. Documents 40 and files 42 are associated with Tgrams 36 and conversation files 38.

Each topic 32 represents a segment of a subject. The pod 12 is focused upon a single subject, and there may be more than one topic 32 associated with a subject. Each subject can represent a pre-defined area of communication which is business oriented. By example the subject can be a research and development initiative having multiple team members 20 who collaborate for the purposes of advancing the R&D initiative. Topic 32 is a subset of the subject for which it is associated, and the sub-topic 34 is a subset of the topic 32 it is associated with. Associated with sub-topic 34 is a topic driven electronic mail communication 36. Documents 40 and files 42 can be attached to or associated with each communication 36. Conversation tangrams 38 represents a series of communications 36 which have been closely associated with each other and designated as a separate hyperlinked information source associated with the topic 32. Comments 39 can be associated to Tangrams 36, conversational T-grams 38, or subtopics 34. A plurality of comments 39 can be associated with a single stem comment 39 or branch off into sub-comments (not shown). FIG. 3 represents a small subset of the possible tangram 36 association strings. Topic driven communications 36 are associated with each other as well. Association of communications is a reference, direct reply, indirect reply, or proximity of information focus between the communications 36.

In an alternative embodiment (not shown) tangrams 36 are directly associated with both topics 32, subtopics 34 and sub-subtopics (not shown). In yet another alternative embodiment multiple layers of sub-subtopics are contemplated under various communication conditions.

In accordance with at least one embodiment the present invention provides a communication management system 10 optimized for collaboration and knowledge sharing. Information gathering and sharing between multiple user is provided in a novel manner. The management system 10 provides significant functionality, including system governance structure, security protocols, communication structure, database structure, trialability, information context, and a single “hub” location for data storage and retrieval. The logical topology of the system provides a hub and spoke orientation. Users are granted access and ultimately connected to a particular hub, which is a central location for information storage and retrieval.

In accordance with at least one embodiment of the present invention, the system 10 includes a plurality of logical modules that provide enhanced functionality. Included within these modules are security, authentication, password retrieval, access rights management, session management, user preference module, content display and personalization module, user management, content management, governance module, content search module, user notification module, I/P content module, module management, and add on module. The security module provides protocol and browser detection as well as SSL certificates. Additionally, the security module can employ IP address restriction, java script detection, robots, and SQL detection. Additional security features are contemplated. Session and content management modules can manage user access rights and user content respectively through out a user session. A user session is any period of time after a user has logged into the system and before the user has logged off. The governance module provides organization to the communications on the system. Organization is necessary to provide the most efficient working environment. In addition, enhanced searching capabilities are supported by the governance module.

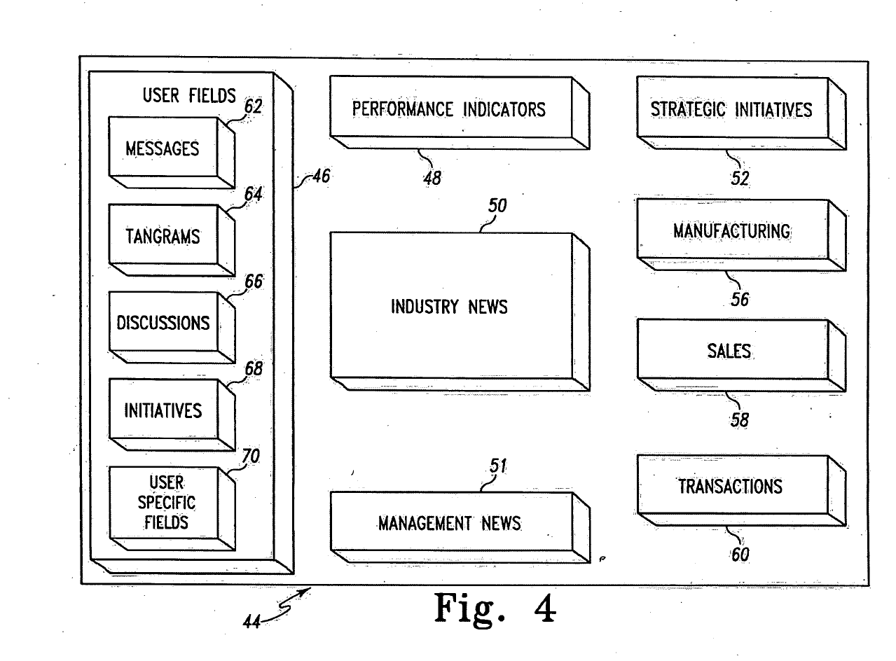

Referring to FIG. 4, a block diagram of the user interface 16 screen shot 44 is shown. The screen shot 44 includes a user field section 46, a performance indicator section 48, an industry news section 50, a management news section 51, a strategic initiatives section 52, a manufacturing section 56, a sales section 58, and a transaction section 60. The user field section 46 includes a messages section 62, a tangram section 64, a discussion section 66, an initiatives section 68 and a user defined information section 70.

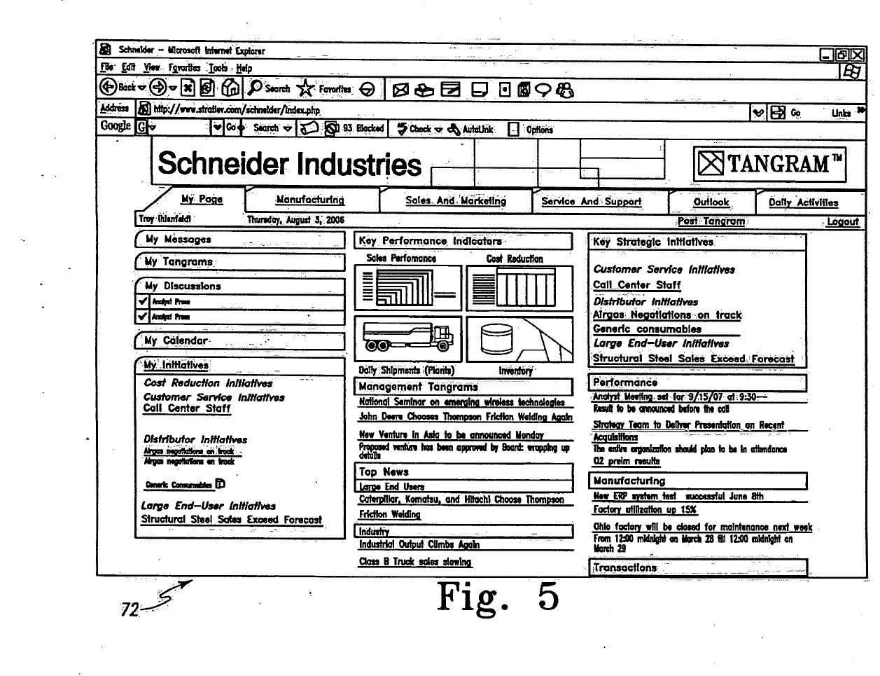

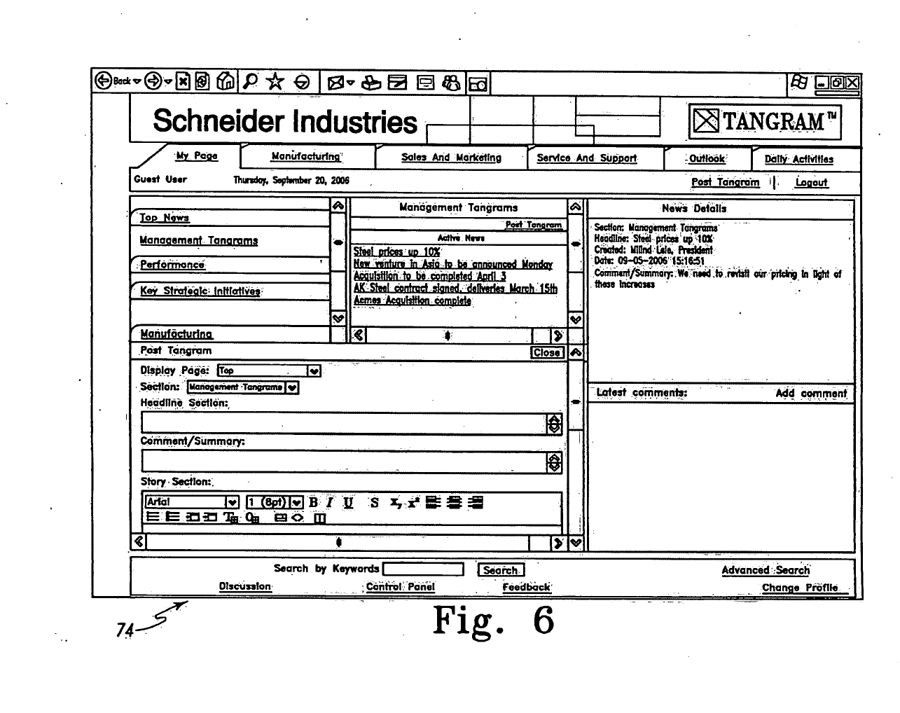

Referring to FIGS. 5-6, an alternative illustrative example of a screen shot 72 is shown. FIG. 5 represents a command view screen shot having hyperlinks and access to a large variety of subject focused information and communication accessibility. FIG. 6 represents the topic driven electronic mail communication 36 access interface screen shot 74. Screen shot 74 provides an illustrative example of a communication interface for users 20 (FIGS. 1-2). FIG. 5 demonstrates the tab structure (business team or function level organization) and the three column format (column 1 on left, column 2 in center, column 3 on right). The right column is information specific to the individual user and includes messages, discussions, and initiatives where the individual has responsibility. Column 2 in the middle focuses on performance indicators specific to the business or functional team, Tangram messages from management and Tangram messages regarding important outside or industry news. The right column is organized around Tangram messages regarding the strategic initiatives of the business or functional team and the ongoing activities of the business.

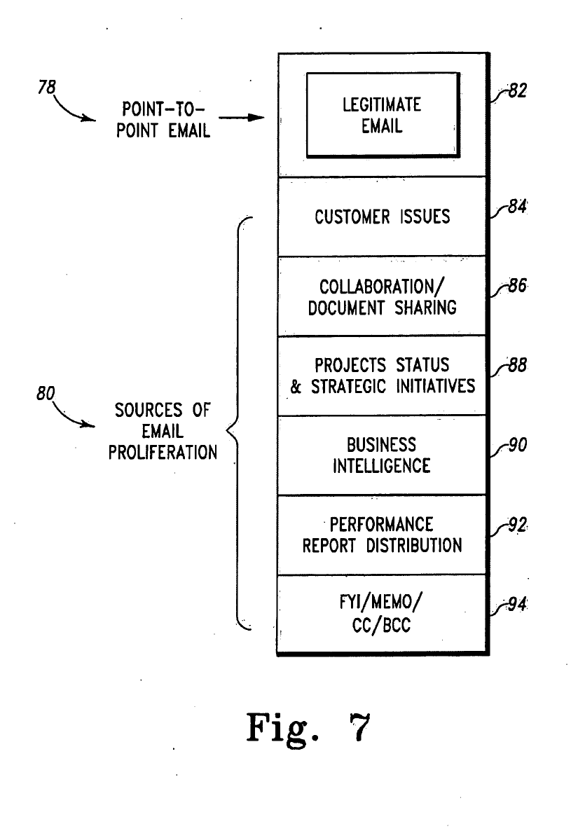

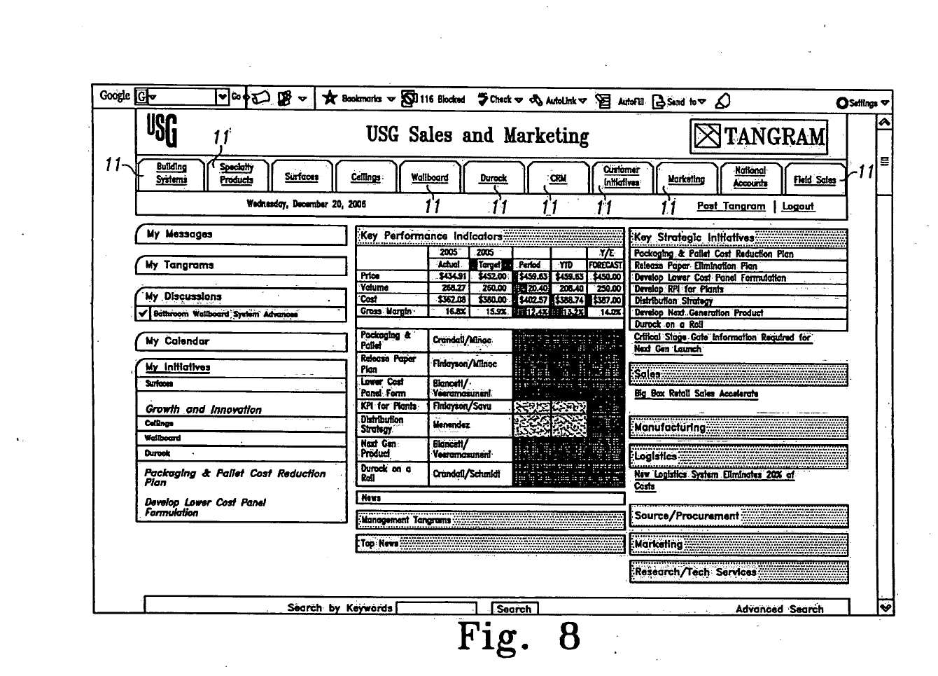

Referring to FIG. 7, an illustrative abstract example of electronic mail types 76 is shown. The e-mail types 76 include point-to-point email 78 and sources of email proliferation 80. Point-to-point email 78 includes legitimate email 82. Email proliferation sources 80 include customer issues 84, collaboration document sharing 86, projects status and strategic initiatives 88, business intelligence 90, performance report distribution 92, and FYI/Memo/cc/bcc communications 94. Embodiments of the novel system 10 reduce proliferation of emails within group 80 while focusing topic communications 78 through the pod 12 (FIGS. 1-2) configuration and structure, one illustrative embodiment as shown in FIG. 3.

Users can post attachments to project or topic areas in any format for team use. This eliminates the messy process of emailing attachments to multiple recipients, improves workflow, helps manage version control, and dramatically reduces backup redundancy. Team members always know the exact location of documents and can discuss the document, get feed back, and request the information they need to complete their work.

The system 10 displays Key Performance Indicators (KPIs) for critical business activities. Data can be pulled from nearly any system or source and posted in any format. Performance reports are no longer buried in user 20 email inbox or sitting in a binder on your desk but displayed according to your preferences on a user 20 front page (FIGS. 4-5). The space can be allocated on every site for this use, however, requires some custom programming. This feature completes the management information picture; data, information, communication and attachments.

Strategic initiatives are outlined and displayed on the site. Work streams that are part of these initiatives are managed by category and displayed in the ‘My Initiatives’ area of the screen shot (FIGS. 4-6) for the user 20 responsible for execution. Groups working on these initiatives are able to share presentations, request data, get feedback and manage document versions.

Individuals can communicate privately with other individuals or selected groups. Blind carbon copy (BCC) and carbon copy (CC) are administrator control options, which are typically employed in specific situations. In an alternative embodiment, there is no CC or BCC option available.

Initiate topical discussions with specific individuals throughout an organization or business entity using the system 10. Track user 20 discussions and make contributions as desired by the user. Attachments and links can be shared and easily reviewed by the group as part of the dialogue.

Topic Driven Exchange are known as “t-grams” and can be organized into pre-established categories by business function, activity, strategy or initiative—information, relevant attachments and comments can be exchanged seamlessly. Users are notified of new “Tangrams” by text being highlighted in blue. Tangrams with new comments are highlighted in green. Importantly, a “my Tangrams” section allows any user to select topic and sub-topics of interest and which aggregate Tangrams and related comments of interest into a reading list for efficient use. It also delivers these critical “t-gram” to the user's Blackberry (or equivalent) when the user is logged off of the system. Users can reply directly to t-grams delivered to their Blackberry—replies are posted to the site. Emails can also be sent to the system 10 and then placed in the relevant topic area. This allows external correspondence to be included in topic areas.

Client/customer work areas can be configured within the system 10. These areas allow client teams to share data and documents, provide updates and collaborate with clients in a secure, password protected environment. Your teams can seamlessly move information from your site to ‘client visible’ areas in one simple step.

The system 10 is Blackberry accessible. Topics that users 20 have selected to appear in the My News section can be delivered to a Blackberry. Users 20 are able to post responses back to the site directly from a wireless device, such as a Blackberry. Key performance indicators and other pre-selected information can also be delivered to mobile devices.

In situations where enterprise solutions have eliminated customized reports or activities that were previously automated, system administrators can integrate these reports and activities into the system.

Tangrams 36 and related comments are displayed clearly and sent through a simple interface. Each category page contains topics on the left, a list of subtopics on in the center column and the main story, attachments and comments on the left. New tangrams 36 and comments are added seamlessly.

Communications 36 are user defined and private, and can define exactly which users are to participate in a discussion and only those users will have access. Attachments can be shared. Alternatively, Tangram communications can be sent via e-mail to external users, such recipients are typically users without granted permanent or temporary access to the tangrams 36. Tangram communications including new comments and topics can be graphically identified in a variety of ways. By example, a new comment can be highlighted with a particular color scheme.

The system 10 also offers semi-customized visual reporting. Rather than digging through excel spreadsheets, high level users 20 can quickly access and assimilate the information they need.

A pod 14 can be associated with a predefined subject comprising the following steps:
The user group is defined and all email addresses are provided to a system administrator.
1. Organizational charts are collected, roles and responsibilities of the top managers are also collected, interviews are conducted with managers to define the page requirements and identify key topics, strategic initiatives, performance indicators and other required information;
2. Mock ups are created and shared with the client management team for approval;
3. Requirements are set for any live or reoccurring data feeds for the performance indicator section;
4. The site is established and reviewed with the managers;
5. “Superusers”/Internal Champions are identified and trained;
6. Sites are preloaded with critical team communications, reports, presentations, project information prior to launch.
7. Once the initial wave of data is moved to the site, the official launch takes place for the organization in a live training or “webinar” format. Each team using the site is trained separately.

Simple, clear information exchange that improves the way groups share information and eliminates CC and BCC email proliferation. News/email information is organized topically by business activity and is designed to specifically meet the needs of an entity. With an interface that is as easy to use as Microsoft Outlook email, any user can post new communications 36 and make comments on communications 36 posted by other users. Private areas can be set up for user groups working on special projects and the service's Urgent Message feature allows for one-to-one private communication when required. Intuition will help to eliminate the following types of email that are currently considered legitimate:
Broadcast information
Announcements
Form distribution
Report distribution
Performance metrics
Strategy updates
Attachment sharing for collaboration purposes
Project work of any type
Discussions

The system 10 provides an organized and novel screen shot 72 for each user based on their role, responsibilities and personal choices. The interface has a crisp, clear design and the messaging tools are simple to use.

Illegitimate and non-essential email will still arrive as email. However, because it is non-essential and the senders are not part of the core work group, users can check it a few times a day and stop responding to it as it comes in.

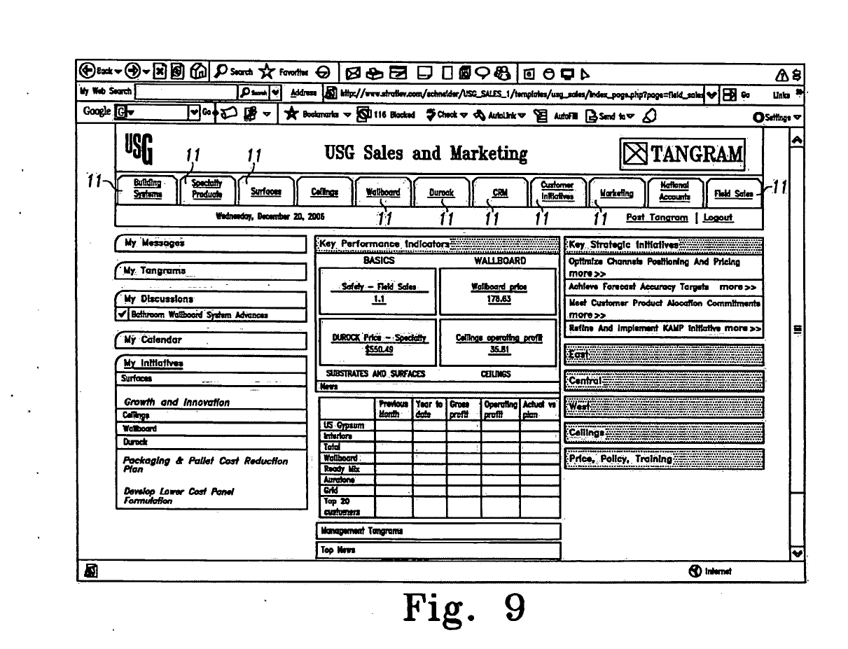

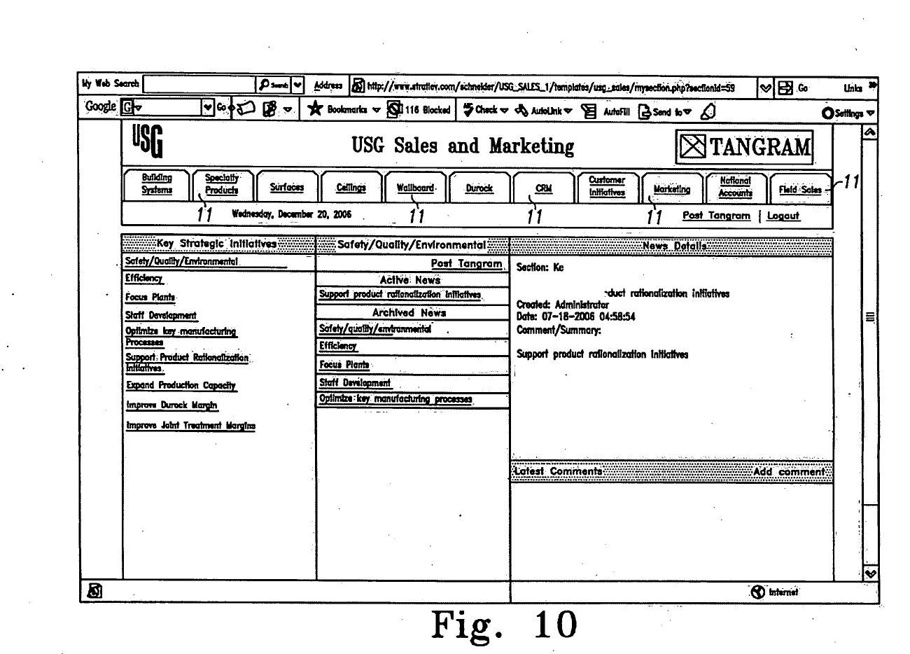

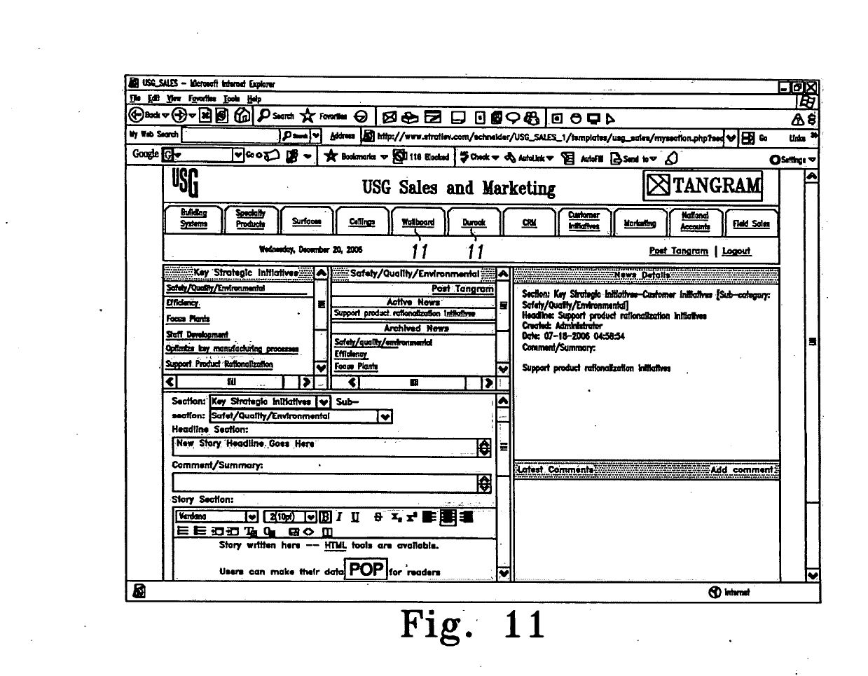

Referring to FIGS. 9-11, an illustrative example of an alternative embodiment of the user interface is shown in FIG. 9. Referring to FIG. 10, Column 1 (left) contains the topic folders listed on the front page. Column 2 (center) lists the Tangram messages posted to the topic highlighted in pink in Column 1 (left). Column 3 (right) contains the story contents and related attachments of the Tangram message headline highlighted in pink in Column 2 (center). All responses to this message and related attachments are also posted in Column 3 (right) under the original story header with the most recent response at the top. In summary, the page displays the topics and sub-topics (left), the headlines of the Tangram messages posted to each topic and sub-topic area (middle), and the related story and attachments in column 3 (right). Now referring to FIG. 11, This figure offers a “next-step” view from FIG. 10. Offering the same three column format, this illustration demonstrates the additional frame added to the lower left hand corner when a user selects “post tangram” from the top right corner of Column 2 (center). Users select the placement of a Tangram message from pull down menus that contain the topic and sub-topic headers provided in Column 1 (left). Users then enter the Tangram message headline, and comment and the message itself. The message area offers HTML formatting and spell check. Users also select the option to add attachments from the local hard drive from this frame. Once the user submits the new Tangram message it will be visible at the top of Column 2 (center) and filed under the select topic or sub-topic area.

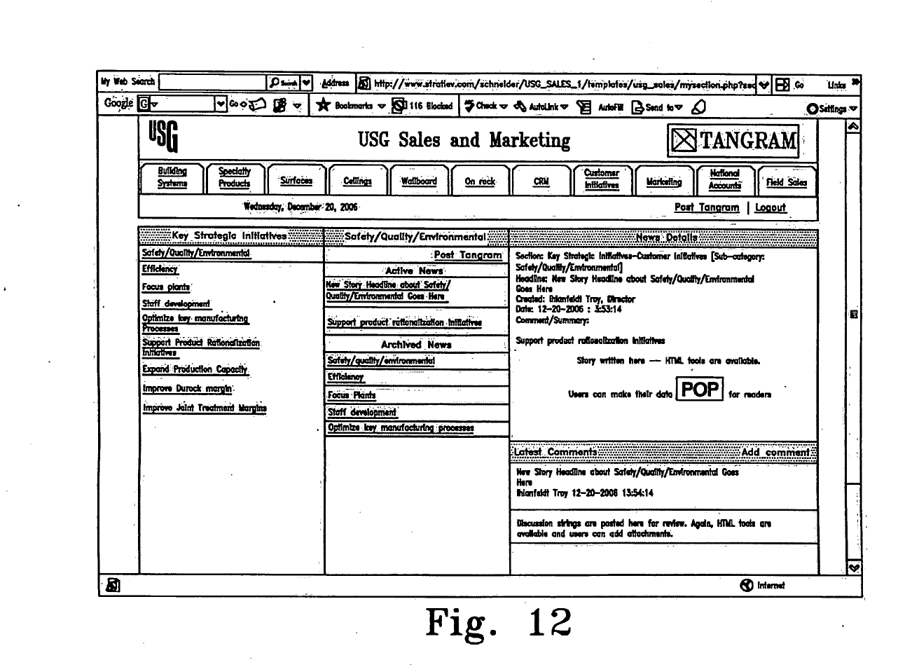

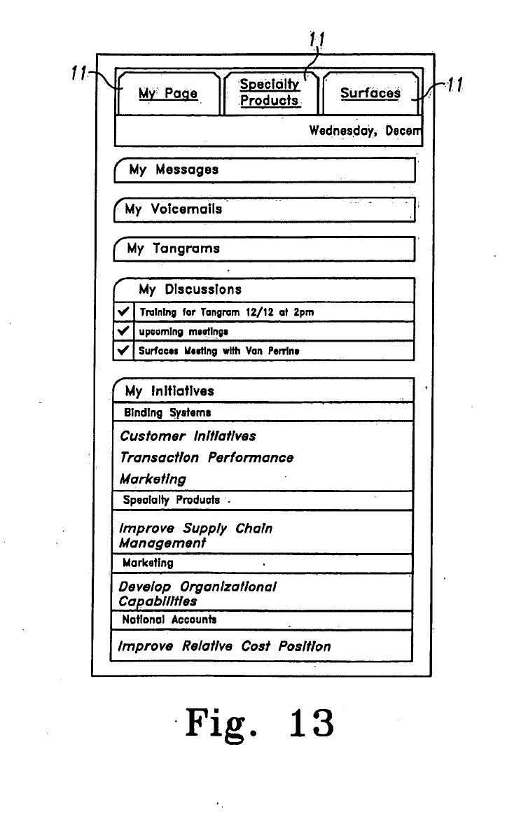

Referring to FIGS. 12-13, a user can select to reply to a Tangram message. This is illustrated in FIG. 12 in the lower right hand corner. A reply is entered and any attachments are selected from the local hard drive. The most recent reply is posted at the top—closest to the original Tangram message. FIG. 13 highlights the individual user section of the site which includes My Messages (basic email), My Tangrams (Tangrams aggregated from the site according to user preferences, and My Discussions (semi-private user defined discussions focused on a topic or output).

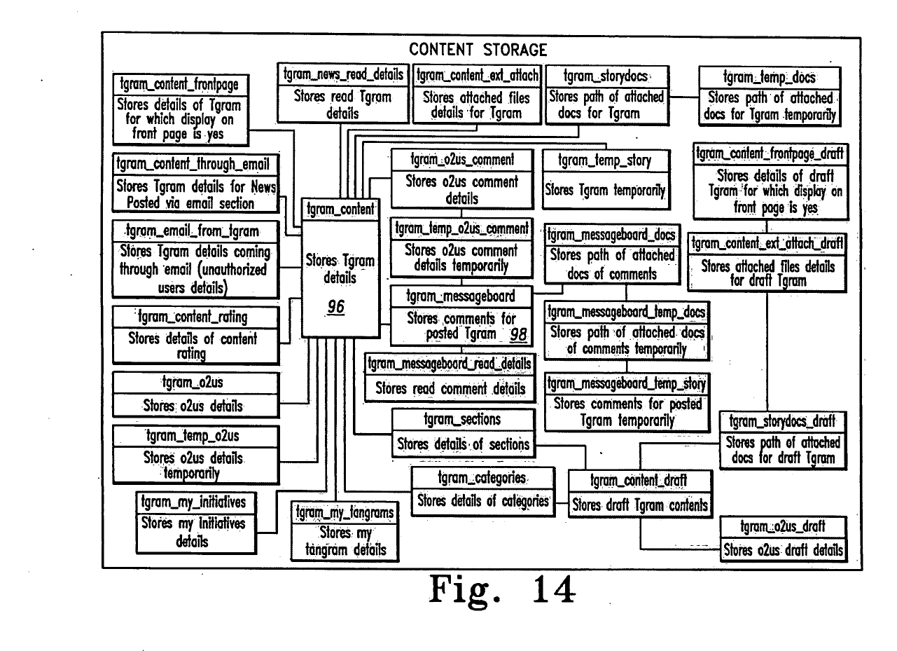

Referring to FIG. 14, an exemplary content storage database schema is provided. Details for each of the t-grams are logically stored in section 96, while the message board section 98 stores comments for a posted t-gram. Additional functional details relating to t-grams are provided within FIG. 14. Alternative data base schema are contemplated for content storage within various embodiments of the present invention.

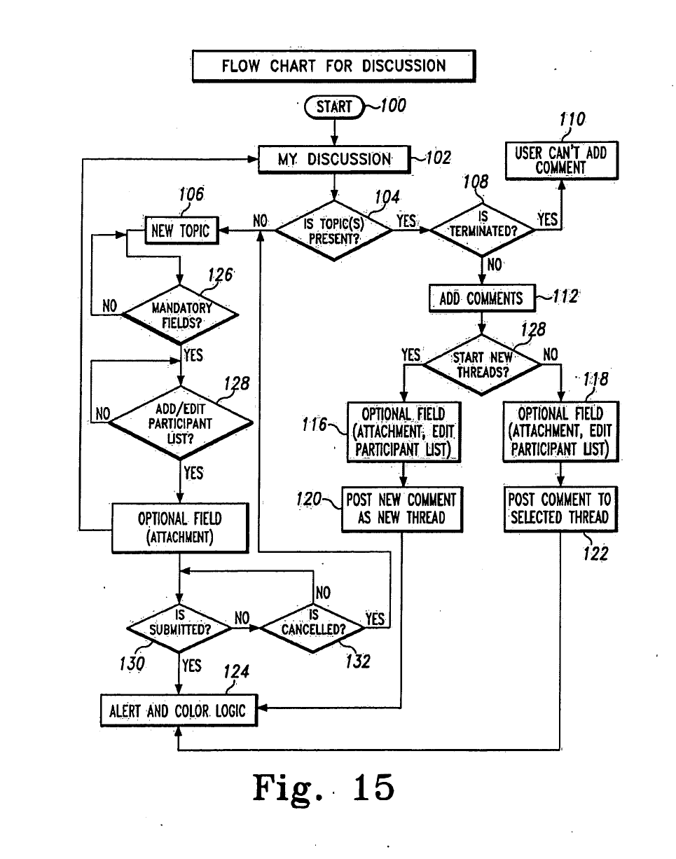

Referring to FIG. 15, a logical flow chart is provided representing a topic based team discussion. Initiation occurs at step 100 for the discussion 102. If the topic presented at step 104 doesn't exist a new topic is created at step 106. If the discussion topic exists, then the system determines if the topic has been terminated at step 108. If it has been terminated, then the user can not provide a comment at step 110, otherwise comments can be added at step 112. New comment thread creation is determined at step 114 and optional fields are selected at steps 116 and 118. The comment can be added as a new thread at step 120 or to a selected thread at step 122. A comment alert and associated comment identification, such as color or font configuration, occurs at step 124. If a new topic is generated at step 106 a decision as to mandatory topic fields occurs at step 126 and whether to add or edit the participant list occurs at step 128. The new comment can be submitted at step 130 or alternatively cancelled at step 132. After the comment is submitted step 124 is activated.

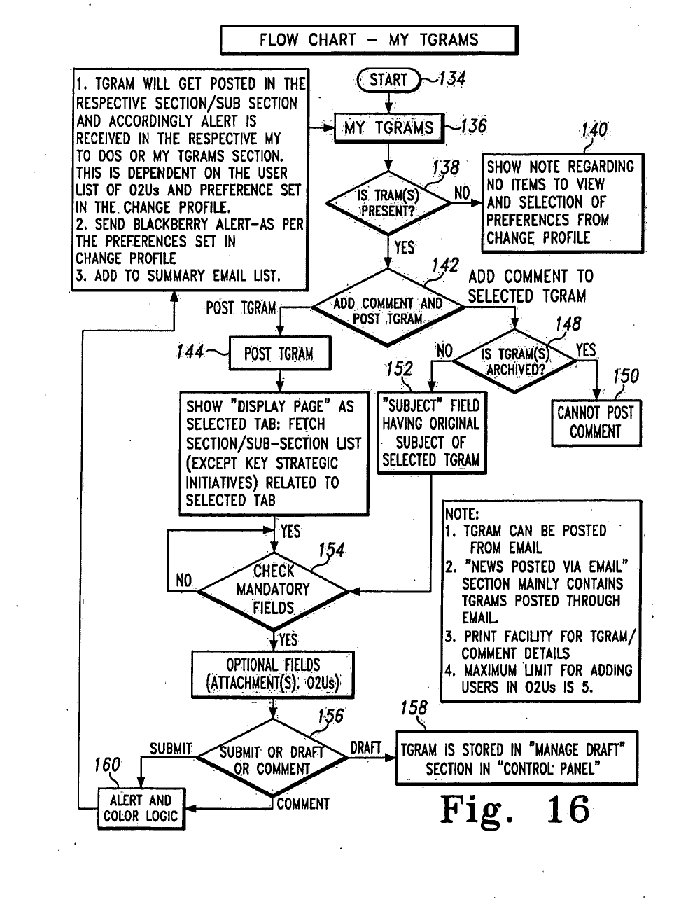

Referring to FIG. 16, a logical flow chart is provided representing a t-gram submission. Initiation occurs at step 134 for t-gram 136. A determination whether the t-gram exists occurs at step 138, if no t-gram present then a no content note is displayed at step 140. If the t-gram is present, then a decision is made at step 142 to either post a t-gram at step 144 or add a comment at step 146. If adding a comment 146 is selected then it is determined whether the t-gram has been archived at step 148. If it has been archived, then the comment can not be posted at step 150, otherwise the subject field is accessed at step 152. A decision whether to check mandatory fields occurs at step 154, which is subsequent to both steps 144 and 152. A decision to submit, draft or comment occurs at step 156. If a draft is generated then it is stored at step 158, otherwise an alert is generated at step 160 indicating whether a submission or comment occurred. The system then reverts to step 136.

In an alternative embodiment, the present invention is contemplated as a functional feature for certain “social networking” environments. A user can provide data in a similar manner as described above, but with a significant difference. The data is personal and social in nature. Pictures, hobbies, vacations, special interests and personal planning are included. By example, the user can set-up a tangram site for their family. Such a site can be limited to family members, and allow the family unit to add, delete, and communicate in an organized electronic forum. Planning for vacations, reunions, weekly or daily activities, and family unit responsibilities are all possible. Tangrams can also include book clubs, sports teams, bands, and professional networking.

Various embodiments of the present invention provide a virtual gated community for users. Users allow access, which cannot be obtained without the user's proactive consent. Since the user does not have a traditional email address (such as myemail@xyz.com) the user cannot receive unwanted messages, such as SPAM. In the event that the user receives unwanted or unauthorized communications, they can simply rescind the sender's access to their tangram site.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. An electronic communication system comprising:
a data file storage pod for organizing data files, wherein the pod data is subject oriented;
a memory storage device for storing data files associated with the pod, wherein the data files are for read and write operations;
a user interface for accessing the data file storage pod, wherein retrieving and storing data files associated with a pod is based upon access criteria;
a CPU for controlling access to the pod and associating data files to the pod.

2. The system according to claim 1, wherein the pod represents a business oriented subject matter.

3. The system according to claim 1, wherein pod data files are hierarchically structured.

4. The system according to claim 2, wherein the subject matter is selected from a group consisting of legal, corporate governance, research and development, human resources, product development, intellectual property, and financial.

5. The system according to claim 3, wherein the data files comprise a topic, a sub-topic and a communication.

6. The system according to claim 3, wherein the data storage pod is a relational database.

7. The system according to claim 6, wherein the database is an object oriented environment.

8. The system according to claim 7, further comprising a security module for maintaining data and user security, and a governance module for organizing and maintaining data structure and access.

9. A method for focusing business communications oriented by topic comprising:
identifying business oriented topics, wherein a user is associated with a topic;
accessing a computer-based communication system, the system comprising,
a data file storage pod for organizing data files, wherein the pod data is subject oriented, and a memory storage device for storing data files associated with the pod, wherein the data files are for read and write operations; and
organizing topic oriented data within an electronically central hub.

10. The method according to claim 9, wherein the user associated topics are defined by a business objective, the topic oriented communications being performed in real-time and hierarchically structured.

11. The method according to claim 9, wherein the topic is a business project.

12. The method according to claim 11, wherein a user team is created for the business project, the team comprising at least one user with access granted to the project.

13. A strategic business management system having a hub and spoke topology, the system comprising:
a relational database configured to logically and centrally focus topics, wherein access to the topics is based upon a user object.

14. The system according to claim 13, wherein the relational database is controlled by a logical hub, system users being represented as logical spokes.

15. The system according to claim 13, wherein the system is logically object-oriented.

16. The system according to claim 13, wherein team data is stored within a memory storage device connected to the relational database, the database being restricted to authorized team members.

17. The system according to claim 15, wherein topics are selected from the group consisting of business management, legal, human resources, and research & development.

18. The system according to claim 15 further comprising a data security module and a system governance module.

19. The system according to claim 15 wherein the governance module provides structure to team communications and data associated with the hub.
